(19) United States
(12) Patent Application Publication
(10) Pub. No.: US 2012/0158557 A1
(43) Pub. Date: Jun. 21, 2012

(54) BUDGET CONTROL CONFIGURATION

(75) Inventors: Heidi Renee Minzner, West Fargo, ND (US); Kimberly J. Kroetsch, Fargo, ND (US); Chen-mi Lin, West Fargo, ND (US); Ramaswamy Narayana, Sammamish, WA (US); Brett Michael Iwen, Glyndon, MN (US); Jeffrey R. Anderson, West Fargo, ND (US)

(73) Assignee: MICROSOFT CORPORATION, Redmond, WA (US)

(21) Appl. No.: 12/973,934

(22) Filed: Dec. 21, 2010

(51) Int. Cl. G06Q 10/00

(52) U.S. Cl. 705/30

(57) ABSTRACT

Concepts and technologies are described herein for budget control configuration. Budgets associated with one or more organizations may be tracked and enforced on transactions associated with the organizations. One or more budgets or financial dimensions associated with the budgets are tracked and managed. Budget funds available calculations can be defined and changed at any time, and can take into account original budgets, amendments to the budgets, expenditures, draft documents, and the like. Entities can specify and update funds considered as budget resources. Budget checks can consider more than one source of funding and track the various sources. Budget checks also can be tailored based upon user permissions, and actions and messaging options can be tailored for users, groups of users, and the like.

### BACKGROUND

Companies, organizations, and/or other entities often operate under a specific budget. For example, various organizations or departments of a particular company may be allocated a budget during or for a particular time period. The budget may be used to support operations associated with the organization or departments of the organization, and operations associated with the organization or departments of the organization may be required not to exceed the specified budget.

Budgets sometimes are entered as dollar or other currency amounts that are tracked during the specified time period. In some embodiments, the budget is tracked based upon an associated account, and balances for that account are updated as budget expenditures or credits are processed. As expenditures or credits are approved and processed, the budgeted funds are decremented or incremented to reflect a new balance associated with the budget. Because transactions against the budget may be required not to exceed the budget at any particular time during a time period associated with the budget, budget balances may be checked before any transaction against the budget is processed or approved.

During the time period associated with the budget, however, a budget may be changed by an organization to reflect various business needs or desires. For example, a department may be downsized or eliminated, and a budget may correspondingly be changed to reflect the new scope of the department. Furthermore, sources for budgets may change during a budget period. Budget tracking software may include hardcoded calculations for determining funds available. Thus, when changes are made to budget amounts or sources, budget tracking and checking software may not capture such changes and or may be difficult or impossible to capture without recoding the budget funds available calculation.

It is with respect to these and other considerations that the disclosure made herein is presented.

### SUMMARY

Concepts and technologies are described herein for budget control configuration. In accordance with the concepts and technologies disclosed herein, budgets associated with one or more organizations may be tracked and enforced on transactions associated with the one or more organizations. According to various embodiments, one or more budgets can be tracked and managed, and various financial dimensions associated with an organization, department, or other entity can be tracked or managed independently and/or collectively. A financial dimension can correspond to a particular purpose, department, type of spending, or the like, associated with an organization, and budgeted funds for the specified financial dimensions can be tracked. Organizations can define the financial dimensions for which budgets are tracked and for which budget controls are desired.

According to various embodiments, budget funds available calculations can be defined and changed at any time. The budget funds available calculation can take into account original budgets, as well as amendments to the budgets via amendments, expenditures, draft documents, and the like. Users also can specify and/or update at any time, funds considered a part of the budgets. Thus, budget funds available calculations can take into account more than one source of funding for an organization, department, or financial dimension, and one or more sources of funding can be tracked and managed. Budget funds available calculation behavior also can be tailored based upon user permissions, and actions and messaging options can be tailored for users, groups of users, and the like.

According to one aspect, a budget control server is configured to execute a budget control application and to store budget control data. The budget control application is executed by the budget control server to track one or more budgets associated with an organization, department, and/or other entity. The budget control application also can be used to configure and track one or more financial dimensions associated with the budgets. When a transaction against a financial dimension is detected, the budget control application determines if a budget check is to be completed before allowing the transaction to proceed.

According to another aspect, the budget checks can be configured via the budget control application. The budget checks can be configured to reflect one or more budget sources, and to take changes to the budgets into account when performing the budget checks. The budget checks also can be configured to pool one or more budget resources. Budget cycles and intervals can be configured by users or other entities, and budgets can be tracked for each financial dimension with respect to the budget cycles and intervals.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a data structure diagram that schematically illustrates budget control data, according to an exemplary embodiment.

FIG. 3 is a flow diagram showing aspects of a method for configuring budget control data, according to an exemplary embodiment.

FIG. 4 is a flow diagram showing aspects of a method for performing a budget check, according to an exemplary embodiment.

FIG. 5 is a computer architecture diagram illustrating an exemplary computer hardware and software architecture for a computing system capable of implementing aspects of the embodiments presented herein.

### DETAILED DESCRIPTION

The following detailed description is directed to concepts and technologies for budget control configuration. According to the concepts and technologies described herein, a budget control server executes a budget control application for tracking and managing budgets, and for enforcing budget controls on transactions associated with entities. According to various embodiments, entities specify financial dimensions corresponding to one or more purposes, departments, users, or the like, for which budget tracking is desired, requested, or needed. Users or other authorized entities interact with the budget control application to specify budgets that are managed and to generate budget control data associated with the budgets.

The budget control data can indicate, for example, transactions that trigger budget checks, user permissions and authorization to conduct various transactions, budget use thresholds for various users or groups of users, budget account information, budget cycles, budget intervals, messaging information for budget check success and failure reporting, and the like. The budget control data can be stored in a data storage location such as a memory device or a budget control data repository in communication with the budget control server. The entities can define an active configuration that includes all settings and preferences associated with a user, budget, and/or other entity. The entities also can define a draft configuration that can be tailored without affecting the functionality of the budget control server. Budget checks can be run in accordance with the active configuration when a specified type of transaction occurs.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for budget control configuration will be presented.

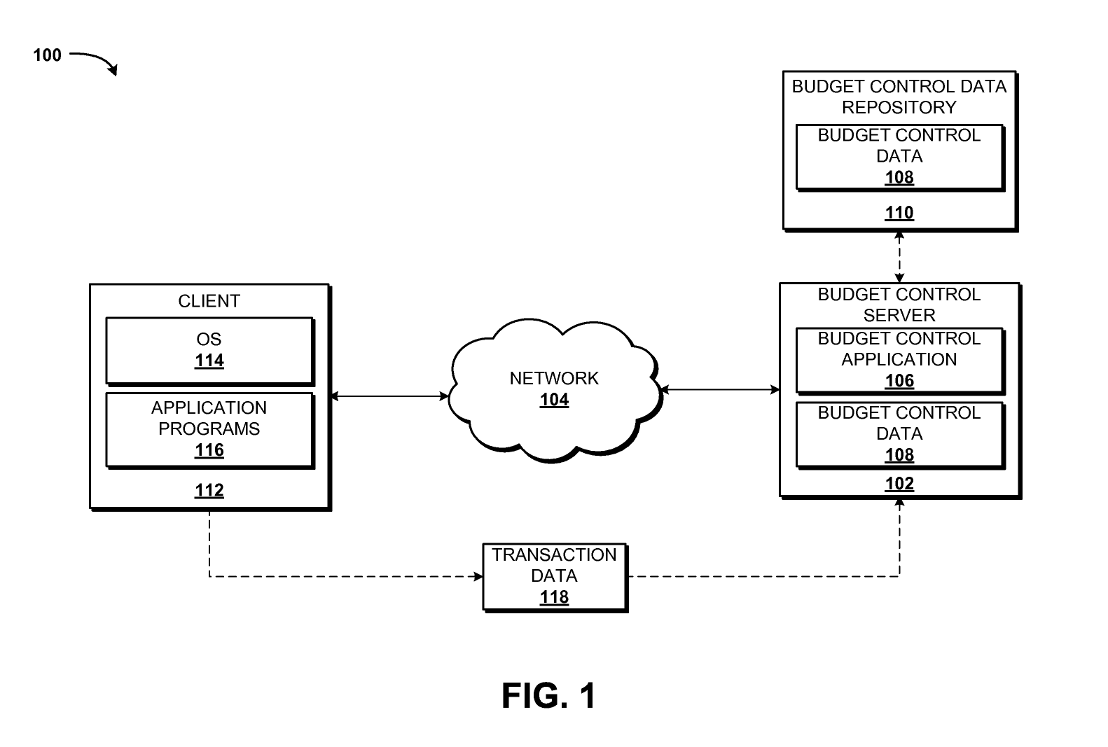

Referring now to FIG. 1, aspects of one operating environment 100 for the various embodiments presented herein will be described. The operating environment 100 shown in FIG. 1 includes a budget control server 102 operating on or in communication with a network 104. The budget control server 102 is configured to execute an operating system (not illustrated in FIG. 1) and one or more application programs such as, for example, a budget control application 106 and/or other application programs. The operating system is a computer program for controlling the operation of the budget control server 102 and the budget control application 106 is an executable program configured to execute on top of the operating system to provide the functionality described herein for configuring and applying budget controls.

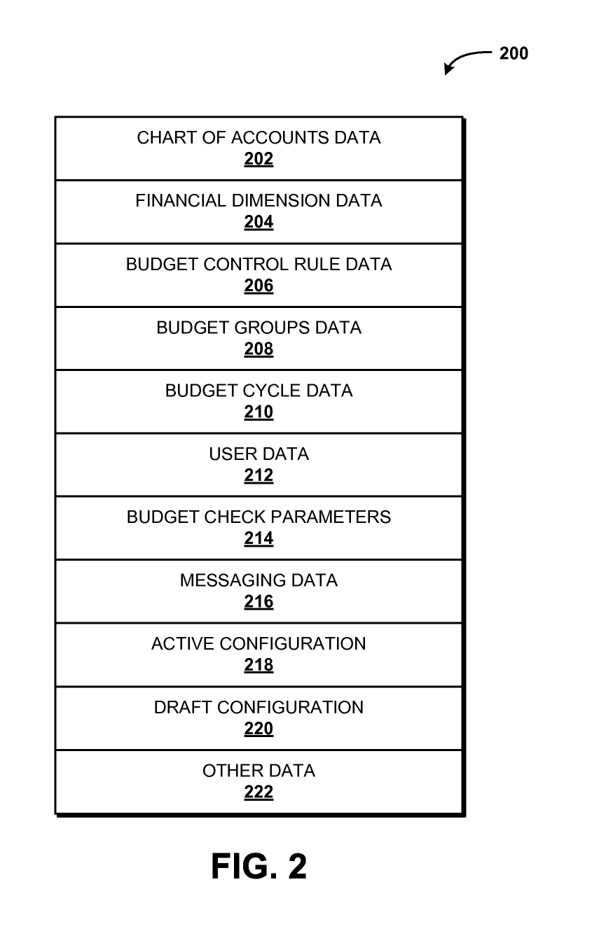

The budget control application 106 is configured to cache or store budget control data 108 at the budget control server 102 and/or at a data storage location in communication with the budget control server 102. The budget control data 108 can be generated by one or more users or other entities communicating with the budget control server 102 via an interface. According to various embodiments, the budget control application 106 presents one or more user interfaces to a user to guide the user through a configuration process in which the user enters budget information, preferences, and/or other configuration information associated with the budget managed and tracked via the budget control application 106. Additional details of the budget control data 108 are described in more detail below with reference to FIGS. 2-4.

According to various implementations, the budget control application 106 is configured to store the budget control data 108 in a budget control data repository 110. The functionality of the budget control data repository 110 can be provided by one or more databases, memory devices, mass storage devices, server computers, desktop computers, mobile telephones, laptop computers, other computing systems, and the like. In the illustrated embodiments, the functionality of the budget control data repository 110 is provided by a database communicatively linked to the budget control server 102. It should be understood that this embodiment is illustrative, and should not be construed as being limiting in any way.

The budget control application 106 also is executable by the budget control server 102 to detect a transaction requiring budget control. In these and/or other events, the budget control application 106 can determine that a transaction for which a budget check should be performed is occurring. In response to this determination, the budget control application 106 can execute a budget check to determine if a budget associated with the user or other entity has sufficient funds for the transaction, and to check permissions associated with the user or other entity to determine if the user or other entity is authorized to complete the transaction.

According to various embodiments, the operating environment 100 includes a client 112 configured to communicate with the budget control server 102. The functionality of the client 112 can be provided by a personal computer (“PC”) such as a desktop, tablet, or laptop computer system. The functionality of the client 112 also can be provided by other types of computing systems including, but not limited to, server computers, handheld computers, netbook computers, embedded computer systems, personal digital assistants, mobile telephones, smart phones, or other computing devices. The client 112 is configured to execute an operating system 114 (“OS”) and one or more application programs (“116”). While the embodiments described herein operate in accordance with a client-server model, it should be understood that the concepts and technologies disclosed herein can be provided as a service, wherein a client-server model may not apply. Thus, the client 112 should be understood as exemplar, and can be replaced with a device that accesses a service provided by the budget control server 102, if desired. As such, the illustrated embodiments should not be construed as being limiting in any way.

The OS 114 is a computer program for controlling the operation of the client 112 and the application programs are executable programs configured to execute on top of the OS 114 to provide various functionality. In some embodiments, the client 112 interfaces with the budget control server 102 via one or more application programming interfaces (“APIs”). For example, the client 112 can interface with the budget control server 102 via a web-based API accessed via a traditional web browser or other web-enabled application program 116. It should be understood that this embodiment is illustrative, and should not be construed as being limiting in any way.

The client 112 is configured to perform a number of operations for interacting with the budget control server 102. According to various embodiments, the client 112 generates transaction data 118 during the interactions with the budget control server 102. The transaction data 118 is received by the budget control server 102 and interpreted to prompt the budget control server to perform various functions. The transaction data 118 can include, for example, queries of the budget control data 108, budget checks, parameters associated with a transaction, and data operations such as creation, reading, updating, and/or deletion of the budget control data 108, and the like. As mentioned above, the transaction data 118 can be associated with a setup process guided by the budget control application 106 and/or another device.

The transaction data 118 also can correspond to actions for creating, updating, and/or deleting the budget control data 108. Thus, the transaction data 118 can correspond to data generated via interactions between the client 112 and/or other devices and the budget control server 102. The interactions with the budget control server 102 can occur, for example, via interactions with one or more UIs generated by the budget control application 106. In some embodiments, a user or other entity interacts with the one or more UIs to input the budget control data 108. As will be explained in more detail with reference to FIG. 2, the budget control data 108 can include, but is not limited to, information describing budgets, budget control dimensions, user information, budget group information, budget cycles and budget intervals, and various configuration files, any and/or all of which can be generated via interactions with the budget control server 102 via one or more UIs.

The transaction data 118 also can correspond to parameters associated with a transaction occurring at the client 112 or other device, for example, a device calling a budget control service. For example, the client 112 may attempt to perform a transaction for purchasing or ordering goods or services. The attempted purchase or order may prompt a budget check, as explained in more detail herein. Parameters associated with the purchase or order, for example an order date, an order amount, a categorization of the purchase, a purchasing user or user group, an account being used for the transaction, other information, and the like, can be obtained or generated and submitted to the budget control server 102 for use in preparing or executing the budget check.

In other implementations, the transaction data 118 corresponds to one or more budget checks or other queries against the budget control data 108. The queries or budget checks can be triggered during financial transactions. For example, the client 112 may be used to generate an order for a product or service via one or more hardware or software devices in communication with the budget control server 102. This order or transaction can be recognized by the budget control application 106. If the budget control application 106 determines that a budget check is to be completed for the transaction, the budget control application 106 triggers a budget check. Additionally, or alternatively, the client 112 can request a budget check explicitly.

During a budget check, one or more budgets associated with the client 112 and/or a user thereof are checked to determine if budget funds are available for the requested products or services. The budget check can be performed against one or more budgets, which collectively or independently may be analyzed to determine if the transaction should be completed. A budget check can succeed or fail, wherein a budget check is deemed to succeed if funds are available to satisfy the budget request and wherein a budget check is deemed to fail if funds are not available to satisfy the budget request.

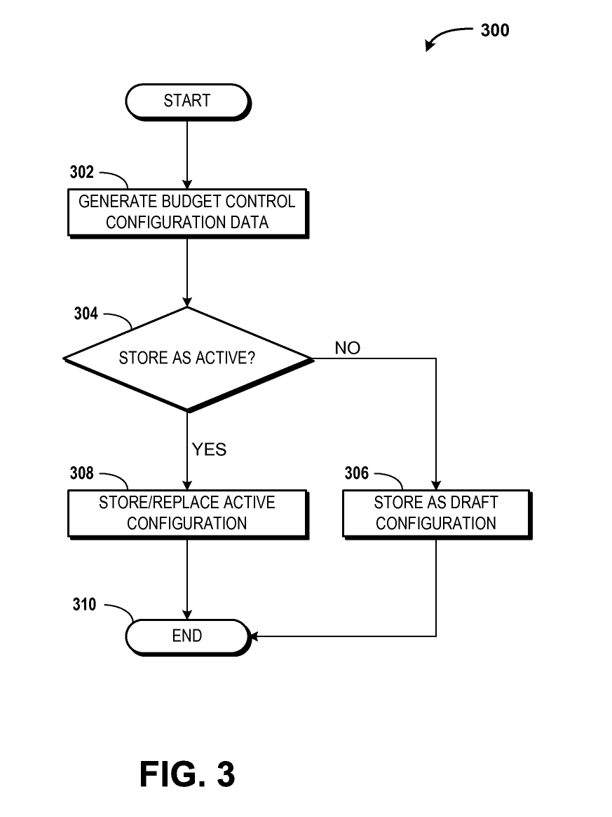

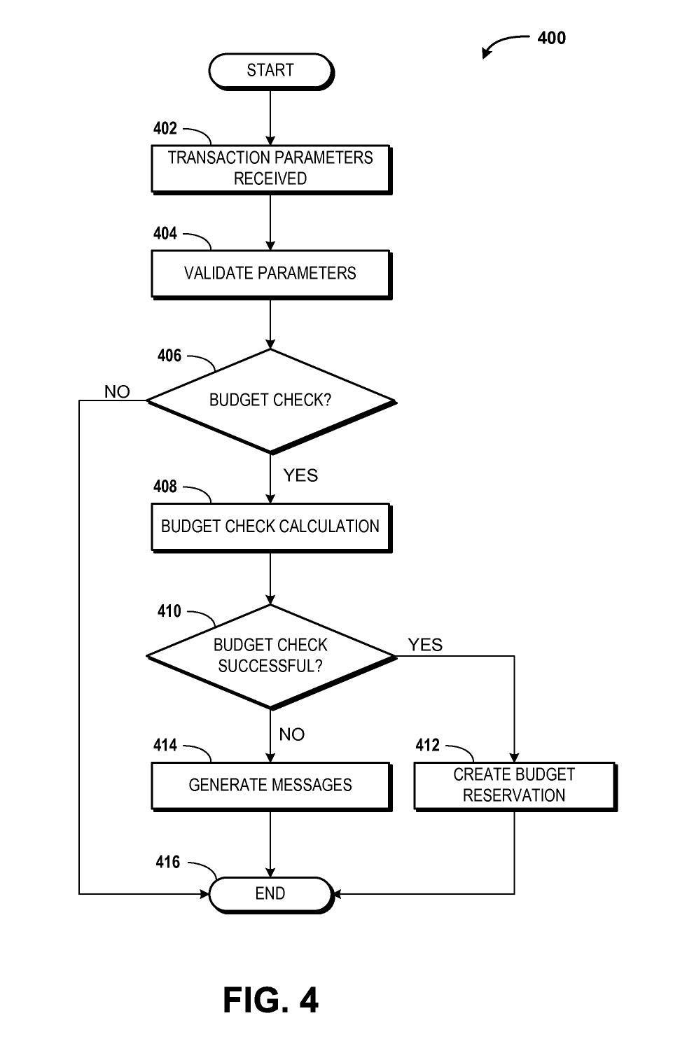

If the budget check succeeds, the budget control application 106 can generate a budget reservation and/or one or more messages indicating the success or success with warnings. In some embodiments, an icon or other indicator can be displayed for informing an entity that the budget check has succeeded. It should be understood that this embodiment is exemplary, and should not be construed as being limiting in any way. If the budget check fails, the budget control application can generate failure messages or warnings. Exemplary methods for configuring budget control data 108 and for executing a budget check calculation are described in more detail herein with reference to FIGS. 3-4.

FIG. 1 illustrates one budget control server 102, one network 104, one budget control data repository 110, and one client 112. It should be understood, however, that some implementations of the operating environment 100 include multiple budget control servers 102, multiple networks 104, multiple budget control data repositories 110, and/or multiple clients 112. Thus, the illustrated embodiments should be understood as being exemplary, and should not be construed as being limiting in any way.

Turning now to FIG. 2, additional aspects of the budget control data 108 are described. In particular, FIG. 2 is a block diagram illustrating a data structure 200 for the budget control data 108, according to an exemplary embodiment of the present disclosure. It should be understood that the illustrated data structure 200 is exemplary, and should not be construed as being limiting in any way. It should be understood that the budget control data 108 can be generated or updated at any time, and that the budget control data 108 can include data relating to more than one user and/or budget. It also should be understood that the categories of data illustrated in FIG. 2 are exemplary, and should not be construed as being limiting in any way. More particularly, the particular names used to describe the various categories of data stored as the budget control data 108 may be conceptual in nature, and are included to facilitate description of the concepts and technologies disclosed herein.

In the illustrated embodiment, the data structure 200 includes chart of accounts data 202, financial dimension data 204, budget control rule data 206, budget group data 208, budget cycle data 210, user data 212, budget check parameters 214, messaging data 216, an active configuration 218, a draft configuration 220, and other data 222. The chart of accounts data 202 includes account structures that contain financial dimensions. According to some embodiments, a user or other entity enters the ledger account data 202 via one or more user interfaces (“UIs”). The UIs can guide the user or other entity through setup steps to enter budget documents such as an original budget, budget amendments, budget transfers, and the like.

The financial dimension data 204 identifies one or more financial dimensions associated with the chart of accounts data 202. The financial dimensions can include, for example, identification of a main or natural account or other entity. The financial dimensions also can include additional dimensions of the budget that a user or other entity wishes to track, enforce budget controls on, and/or otherwise manage using the budget control server 102. According to some embodiments, for example, a particular business may have an overall budget for all operations, which may be reflected in the chart of accounts data 202 described above and as the main or natural account in the financial dimension data 204. Additionally, or alternatively, the user or entity may wish to track and/or enforce budget control and usage associated with a number of operations or purposes such as information technology budgeting and spending, office supplies budgeting and spending, procurement budgeting and spending, capital expenditure budgeting and spending, marketing budgeting and spending, other purposes, combinations thereof, and the like. The financial dimension data 204 identifies what purposes and/or accounts are tracked and/or for which budget controls are enforced.

The budget control rule data 206 identifies combinations of financial dimensions or purposes for which budgets are tracked, enforced, and/or for which budget checks are required prior to creating budget reservations. Thus, the budget control rule data 206 can specify, for example, that budget checks are required for purchasing information technology assets or services and office supplies. It should be understood that this budget rule is exemplary, and that other combinations of financial dimensions are contemplated. More generally, it should be understood that the budget control rule data 206 includes data describing types of activity, combinations of activities, and/or other transactions that invoke budget checks.

The budget groups data 208 defines one or more budget groups associated with one or more budgets or budget control rules. More particular, the budget groups data 208 can be used to identify one or more pools of budget resources such as budgets and/or accounts that may be pooled together for budget checks when budget checks are invoked. Thus, for example, the budget groups data 208 can identify a combination of budgets that may be checked with respect to a particular type of activity or a combination of activities such as spending or other transactions. In one example, if a user attempts to purchase office supplies, and if the budget control rule data 206 identifies office supply purchases as an activity that invokes budget checking, the budget groups data 208 can define a pool of resources or budgets that may be checked for the activity that invoked the budget check. In the provided example, the budget groups data 208 may define a pool of budget resources including budgets for office supply spending and marketing spending, and may allow the budget check to be executed against the pool of these resources. This example is illustrative, and should not be construed as being limiting in any way.

The budget cycle data 210 describes time intervals and/or cycles associated with budgets. Thus, the budget cycle data 210 can describe one or more time intervals or time spans associated with budgets, time limitations associated with the budgets, and the like. In some embodiments, for example, the budget cycle data 210 defines a fiscal year model for a budget, thereby specifying that a budget limit is set and enforced based upon a fiscal year model and specifying when the fiscal year begins and ends. In other embodiments, the budget cycle data 210 defines a budget cycle for budgets. Exemplary budget cycles include, but are not limited to, budget cycles that renew daily, weekly, bi-weekly, semi-monthly, monthly, semi-annually, annually, biannually, and/or the like.

The user data 212 defines one or more users associated with the budgets tracked or enforced by the budget control server 102. The user data 212 identifies users or groups of users associated with budgets and/or combinations of budgets. Additionally, the user data 212 stores data relating to users and/or user groups' permissions. Thus, the user data 212 can define which users are approved to spend with regard to a particular budget or combination of budgets, and other permissions associated with the users. In some embodiments, the user data 212 defines user permissions to exceed or be constrained by budget spending thresholds. The budget spending thresholds can range from less than the total budget to amounts exceeding the total budget. Thus, some users may be allowed to exceed budgets for some types of spending, where other users may only be allowed to spend up to a defined portion of the budget such as eighty five percent, and the like. These examples are illustrative, and should not be construed as being limiting in any way.

The budget check parameters 214 define the budget check calculation. The budget check parameters 214 therefore can be used to define how the actual budget checks are performed against the budgets, and what amounts are included in the budgets tracked and/or enforced. The budget check parameters 214 can include, for example, figures reflecting original budgets, draft budget amendments, budget amendments, budget transfers, draft budget transfers in, draft budget transfers out, carry forward budget, budget reservations for pre-encumbrances, draft budget reservations for pre-encumbrances, budget reservations for encumbrances, draft budget reservations for encumbrances, carry forward encumbrances, actual expenditures, carry forward actual expenditures, unposted actual expenditures, and the like. Additionally, the budget check parameters 214 can identify how the other budget check parameters 214 are combined and/or enforced against proposed spending or other activities to enforce budget controls.

The messaging data 216 can define messages generated and/or suppressed by the budget control server 102 during budget checks. The messaging data 216 also can include references to the user data 212, which may be used to adjust what messages are generated or suppressed with respect to particular users. In some embodiments, for example, the budget control server 102 generates detailed messages when budget checks fail or succeed. The detailed messages may include sensitive information such as total budgets available, account numbers, and the like. Some users may or may not be authorized to view sensitive information in an effort to address security or other considerations. The messaging data 216 can define these and other messaging features associated with the budget control server 102.

The active configuration 218 stores the customizable values for the budget control server for use during budget checks. It should be understood that the customizable values can include all data described herein including the data described herein with reference to FIG. 2. The draft configuration 220 can include a draft configuration for the budget checks. Thus, the draft configuration 220 can include some, all, or none of the customizable values for the budget control server for use during budget checks. According to some embodiments, users can use the active configuration 218 while the configuring the draft configuration 220. If the user elects to begin using the draft configuration 220, the active configuration 218 is replaced with the draft configuration 220.

The other data 222 can include various types of data associated with the budget control server 102, the budget check calculations, and/or users of the budget control server 102. In some embodiments, the other data 222 includes authentication data for users, license information for the budget control application 106, personalization, customization, and/or configuration information for the budget control server 102 and/or the budget control application 106, and the like.

Turning now to FIG. 3, aspects of a method 300 for storing the budget control data 108 will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods disclosed herein, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the budget control server 102 via execution of the budget control application 106. It should be understood that these embodiments are exemplary, and should not be viewed as being limiting in any way. Additional and/or alternative devices can provide the functionality described herein via execution of additional and/or alternative applications. The method 300 begins at operation 302, wherein the budget control server 102 generates the budget control data 108. According to various embodiments, the budget control application 106 presents one or more UIs for guiding a user through the process of inputting data corresponding to the budget control data 108.

According to an exemplary embodiment, the budget control application 106 is executable by the budget control server 102 to present a UI for obtaining the budget control data 108. More particularly, the budget control server 102 is configured to present a UI with one or more sections, tables, and/or pages for obtaining data from the user or another entity. According to some embodiments, the budget control server 102 presents a UI or a section, page, or tab of a UI for each of the types or categories of data described herein with reference to FIG. 2. A user or other entity can enter data via the UI and the budget control server 102 can store the received data as the budget control data 108. In some embodiments, data received from the user or other entity is cached in a data storage location until the user disconnects from the budget control server 102 or otherwise commits changes to the budget control data 108. It should be understood that a user or other entity can update the budget control data 108 at any time.

From operation 302, the method 300 proceeds to operation 304, wherein the budget control server 102 determines if the budget control data 108 generated in operation 302 should be stored as the active configuration 218. According to various embodiments, the budget control server 102 can be configured to assume by default that the budget control data 108 or changes thereto received by the budget control server 102 are not to be stored as the active configuration 218. Thus, in some embodiments, a user or other entity must explicitly indicate that the budget control data 108 is to be saved as the active configuration 218 or the budget control data 108 is discarded or stored as the draft configuration 220. In other embodiments, changes to the budget control data 108 are by default saved to the active configuration 218 if the user or other entity disconnects from the budget control server 102. In yet other embodiments, the budget control application 106 presents a UI control to the user or other entity for selecting whether or not the changes to the budget control data 108 are to be saved to the active configuration 218. It should be understood that the above examples are illustrative, and should not be construed as being limiting in any way.

If the budget control server 102 determines in operation 304 that the budget control data 108 should not be stored as the active configuration 218, the method 300 proceeds to operation 306, wherein the budget control server 102 stores the budget control data 108 as the draft configuration 220. If the budget control server 102 determines, in operation 304, that the budget control data 108 defined in operation 302 should be stored as the active configuration 218, the method 300 proceeds to operation 308, wherein the active configuration 218 is updated, generated, or replaced, and stored at the budget control data repository 110 as the active configuration 218.

As mentioned above, changes to the budget control data 108 can be stored in a cache or other data storage location, if desired. Thus, though not illustrated in FIG. 3, operations 306 and 308 can include clearing the cache or other data storage location when the active configuration 218 or the draft configuration 220 is saved. From operation 308 or operation 306, the method 300 proceeds to operation 310. The method 300 ends at operation 310.

Turning now to FIG. 4, aspects of a method 400 for performing a budget check will be described in detail. The method 400 begins at operation 402, wherein the budget control server 102 receives parameters associated with a financial transaction. As explained herein with reference to FIG. 1, the parameters received by the budget control server 102 can include transaction data 118 received and/or input by the client 112 during a financial transaction such as an attempted purchase. The parameters can be obtained from other sources. As such, it should be understood that this example is illustrative, and should not be construed as being limiting in any way.

From operation 402, the method 400 proceeds to operation 404, wherein the budget control server 102 validates the parameters received in operation 402. Exemplary validation steps include, but are not limited to, converting a received currency into the budget currency to ensure that the amount checked against the budget is in the correct currency, checking transaction dates and budget dates to ensure the dates are valid, validating users to ensure the users have permission to complete the transactions and to verify budget limits or thresholds, verifying user permissions for messaging purposes, and the like. Although not illustrated in FIG. 4, it should be understood that the budget control server 102 can interrupt or stop the financial transaction if the budget control server 102 determines that the transaction parameters are not valid. Thus, the operations described herein for unsuccessful budget checks also can be performed if the transaction parameters are determined by the budget control server 102 to be invalid.

From operation 404, the method 400 proceeds to operation 406, wherein the budget control server 102 determines if a budget check is to be completed. The determination by the budget control server 102 as to whether a budget check is to be completed can be based upon the received and validated transaction parameters. The budget control server 102 also can be configured to determine that a budget check is to be completed based upon a type of transaction detected by the budget control server 102. Budget checks also can be triggered based upon a time, date, month, or other information associated with the transaction detected by the budget control server 102, and/or based upon rules or schedules for completing budget checks.

In some embodiments, the budget control server 102 determines that the budget check is to be completed based upon the active configuration 218, which can specify particular types of activities that trigger or prompt a budget check. Even if not specified in the active configuration 218, the budget control server 102 can be configured to complete budget checks for certain activities. Exemplary activities include, but are not limited to, attempted purchases or purchase order processing. During processing of a purchase or purchase order, a budget check may be invoked to determine if funds are available to complete the transaction. Other activities and/or configurations can trigger budget checks, according to user or software needs, preferences, and/or configurations.

If the budget control server 102 determines in operation 406 that a budget check is to be completed, the method 400 proceeds to operation 408, wherein the budget control server 102 performs the budget check. The budget check can be configured by a user or other entity, or can be configured by the budget control application 106. According to various embodiments, the budget check calculation is completed by examining the received and validated parameters and the budget control data 108, and determining if one or more budgets associated with a user or other entity support the transaction associated with the parameters in light of the validated parameters and the budget control data 108.

As explained above with reference to FIG. 2, the budget check can be defined by the budget check parameters 214, which may specify what accounts, budgets, and/or other budget resources are checked, how the budget resources are pooled, budget cycles or intervals that apply to the pooled and checked budget resources, how the budget resources are grouped for a particular transaction, and thresholds and/or permissions for a user associated with the transaction. Thus, it will be appreciated that the budget control server 102 can examine the budget control data 108 to build and execute the budget check based upon one or more of the chart of accounts data 202, the financial dimension data 204, the budget control rule data 206, the budget group data 208, the budget cycle data 210, the user data 212, the budget check parameters 214, and/or the other data 222. As explained above, one or more values associated with the examined data may be stored as the active configuration 218, if desired.

According to various embodiments, budget checks are configured by users or other entities, associated with various activities or types of activities, and stored as the budget control data 108. Additionally, budget checks can be configured at runtime by the budget control application 106. Thus, the budget checks performed in operation 408 can include budget checks configured at any time, including runtime.

From operation 408, the method 400 proceeds to operation 410, wherein the budget control server 102 determines if the budget control check performed in operation 408 is successful. As explained above, the budget check can include checking one or more budgets to see if budget funds are sufficient to allow a requested transaction to proceed. Thus, the determination that a budget check is successful can include a determination that the budget funds are sufficient to support the requested transaction, that a user has authority to exceed the budgets associated with the requested transaction, and/or that the budget funds are within a specified threshold usage of the budget funds. Similarly, a determination that the budget check is not successful can include a determination that the budget funds are insufficient to support the transaction, that a user does not have authority to complete the requested transaction, that the budget funds used by the transaction exceed a specified threshold usage of the budget funds, and the like.

If the budget control server 102 determines in operation 410 that the budget check is successful, the method 400 proceeds to operation 412. In operation 412, the budget control server 102 generates a budget reservation in accordance with the transaction. According to various embodiments, the budgets can be updated to reflect the transaction, activity logs can be updated to show the transaction, and/or messages can be generated. Messages can include messages to procurement or purchasing entities to process purchase orders or purchases, clearance of attempted purchases, and the like. Additional activities can be completed in response to budget reservations and/or successful completion of budget checks

If the budget control server 102 determines in operation 410 that the budget check was not successful, the method 400 proceeds to operation 414, wherein the budget control server 102 generates one or more messages. As explained above with reference to FIG. 2, the messages can include, but are not limited to, one or more failure messages such as warnings indicating that the budget check is not successful, data indicating budget balances, and/or other types of information. For example, the messages can include warnings that the requested transactions exceed budgeted spending, and/or that a user is not authorized to complete the transaction.

The messages can be generated and sent to a number of entities, and/or can be presented to a user via a user interface. Thus, the budget check and messaging functions of the budget control server 102 can be used to prevent or detect certain types of spending and/or when spending exceeding user authority or budget levels are detected.

Although not illustrated in FIG. 4, the budget control server 102 can take other actions in response to unsuccessful budget checks. For example, the budget control server 102 can deny creation of a budget reservation, block processing of payment for the transaction, instruct other devices or entities to deny completion of the requested transaction, and/or other take other actions with respect to the requested transaction. From operations 412 and 414, the method 400 proceeds to operation 416. Also, if the budget control server 102 determines in operation 406 that budget check is not to be completed, the method 400 proceeds to operation 416. The method 400 ends at operation 416.

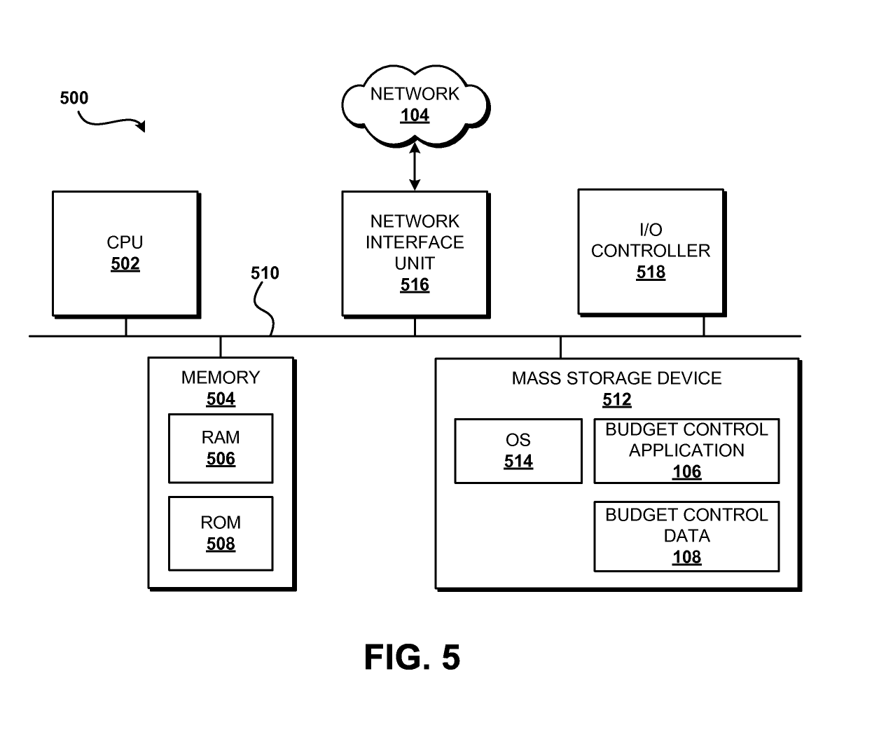

FIG. 5 illustrates an exemplary computer architecture 500 for a device capable of executing the software components described herein for budget control configuration. Thus, the computer architecture 500 illustrated in FIG. 5 illustrates an architecture for a server computer, mobile phone, a PDA, a smart phone, a server computer, a desktop computer, a netbook computer, a tablet computer, and/or a laptop computer. In one embodiment, the computer architecture 500 illustrated in FIG. 5 illustrates an architecture for the budget control server 102. This embodiment is exemplary and should not be construed as being limiting in any way. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 514 and the budget control application 106. According to various embodiments, the mass storage device 512 also can be configured to store the budget control data 108, if desired.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium” and variations thereof, does not include waves, signals, and/or other transitory and/or intangible communication media, per se.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the budget control data repository 110 and/or the client 112. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

Based on the foregoing, it should be appreciated that technologies for budget control configuration have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A computer-implemented method for performing a budget check, the computer-implemented method comprising performing computer-implemented operations for:
receiving, at a budget control application, transaction data associated with a transaction;
determining, based upon the transaction data and budget control data, whether the budget control application is to perform a budget check before the transaction is completed;
in response to determining that the budget control application is to perform the budget check, formatting a budget check based, at least partially, upon the budget control data;
executing the budget check; and
determining if the budget check is successful.

2. The method of claim 1, further comprising in response to determining that the budget check is not to be performed, creating a budget check reservation associated with the transaction.

3. The method of claim 1, further comprising in response to determining that the budget check is successful, creating a budget check reservation corresponding to the transaction.

4. The method of claim 1, further comprising in response to determining that the budget check is not successful, generating a message for delivery to an entity, the message indicating that the budget check failed and describing the transaction.

5. The method of claim 3, further comprising generating an indicator for informing an entity that the budget check succeeded.

6. The method of claim 1, further comprising:
generating the budget control data; and
storing the budget control data at a data storage location accessible to the budget control application.

7. The method of claim 6, wherein generating the budget control data comprises receiving data via the budget control application, the data comprising input received via interactions with a user interface presented by the budget control application.

8. The method of claim 6, further comprising:
determining if the budget control data is to be stored as an active configuration; and
in response to determining that the budget control data is to be stored as the active configuration, storing the active configuration.

9. The method of claim 8, further comprising in response to determining that the budget control data is not to be stored as the active configuration, storing the budget control data as a draft configuration.

10. The method of claim 1, wherein the budget control data comprises chart of accounts data identifying at least one account associated with a budget managed by the budget control application and financial dimension data identifying at least one financial dimension for which budget controls are enforced.

11. The method of claim 5, wherein the indicator comprises an icon displayed on a user interface for interacting with the budget control server.

12. The method of claim 1, wherein the budget control data further comprises budget cycle data identifying a budget cycle associated with the budget.

13. The method of claim 1, further comprising validating the transaction data to determine if the budget check is to be performed, the transaction data comprising transaction parameters associated with the transaction, and the transaction comprising a financial transaction occurring at a client in communication with a budget control server hosting the budget control application.

14. The method of claim 1, wherein the budget check comprises analyzing a pool of budget resources associated with one or more financial dimensions, the financial dimensions comprising spending purposes associated with the budget.

15. A computer-implemented method for performing a budget check, the computer-implemented method comprising performing computer-implemented operations for:
receiving, at a budget control application, transaction data associated with a financial transaction occurring at a device in communication with the budget control application;
accessing budget control data to determine whether the financial transaction is a type of transaction for which a budget check is to be performed before the financial transaction is completed;
in response to so determining, validating the transaction data and formatting a budget check based, at least partially, upon the budget control data;
executing the budget check based, at least partially, upon an analysis of the budget control data;
determining if the budget check is successful; and
generating a message indicating the outcome of the budget check, the message being submitted to at least one authorized entity associated with the budget.

16. The method of claim 15, further comprising:
in response to determining that the budget check is not to be performed, creating a budget check reservation associated with the financial transaction;
in response to determining that the budget check is successful, creating a budget check reservation corresponding to the financial transaction and generating a message for delivery to at least one authorized entity associated with the budget, the message indicating that the budget check succeeded and describing the financial transaction and the budget reservation; and
in response to determining that the budget check is not successful, generating a failure message for delivery to the at least one authorized entity, the failure message indicating that the budget check failed and describing the financial transaction.

17. The method of claim 15, further comprising:
generating the budget control data based upon data received via interactions with the client via interactions with a user interface presented by the budget control application; and
storing the budget control data at a data storage location accessible to the budget control application.

18. The method of claim 6, further comprising:
determining if the budget control data is to be stored as an active configuration;
in response to determining that the budget control data is to be stored as the active configuration, storing the active configuration; and
in response to determining that the budget control data is not to be stored as the active configuration, storing the budget control data as a draft configuration.

19. A computer storage medium having computer readable instructions stored thereupon that, when executed by a computer, cause the computer to:
receive, at a budget control application hosted by a budget control server, transaction data associated with a financial transaction occurring at a client in communication with the budget control server;
access budget control data stored at a data storage device accessible to the budget control server to determine whether the financial transaction is a type of transaction for which a budget check is to be performed before the financial transaction is authorized for completion;
in response to determining that the financial transaction is the type of transaction, validate the transaction data and format a budget check based, at least partially, upon the budget control data;
execute the budget check based, at least partially, upon an analysis of the budget control data and results from validating the transaction data;
determine if the budget check is successful;
in response to determining that the budget check is successful, create a budget check reservation corresponding to the financial transaction and generate a message for delivery to at least one authorized entity associated with the budget, the message indicating that the budget check succeeded and describing the financial transaction and the budget reservation; and
in response to determining that the budget check is not successful, generate a failure message for delivery to the at least one authorized entity, the failure message indicating that the budget check failed, the financial transaction, and identifying at least one user associated with the client.

20. The computer storage medium of claim 19, further comprising instructions that, when executed by the computer, cause the computer to:
generate the budget control data based upon data received from the client via interactions with at least one user interface presented by the budget control application;
determine if the budget control data is to be stored as an active configuration or a draft configuration;
in response to determining that the budget control data is to be stored as the active configuration, storing the active configuration; and
in response to determining that the budget control data is not to be stored as the active configuration, storing the budget control data as the draft configuration.
